(19) United States
(12) Patent Application Publication
(10) Pub. No.: US 2008/0044115 A1
(43) Pub. Date: Feb. 21, 2008

(54) Packaging Bag With Fastener And Method Of Producing The Same

(75) Inventors: Tooru Ichikawa, Tokyo (JP); Kou Go, Tokyo (JP); Kazuhiro Umenaka, Tokyo (JP)

Correspondence Address: YOUNG & THOMPSON, 745 SOUTH 23RD STREET, 2ND FLOOR, ARLINGTON, VA, 22202, US

(73) Assignee: HOSOKAWA YOKO CO., LTD., TOKYO JAPAN (JP)

(21) Appl. No.: 11/628,758

(22) PCT Filed: May 31, 2005
(86) PCT No.: PCT/JP05/09978

§ 371 Date: Dec. 7, 2006

(30) Foreign Application Priority Data
Jun. 10, 2004 (JP) 2004-172922

(51) Int. Cl. B65D 33/38; B31B 1/74

(52) U.S. Cl. 383/204; 493/213

(57) ABSTRACT

There is provided a packaging bag capable of easily taking out an inner content of a desired amount from a packaging bag. The packaging bag provided with a fastener forms a packaging bag 1 by connecting a bag body 2 to a spout unit 3 as an independent member. The spout unit 3 is composed of opposing wall surface portions 11 and a fastener provided on inner surfaces of these wall surface portions 11, which are integrally formed through an injection molding process. The spout unit 3 includes a connection opening 15 for connecting one side end to the bag body 2 with the fastener 13 being boundary thereof and a closed portion 16 forming the other side end as the end edge of the packaging bag. A seal-opening portion 20 to be torn so as to separate the spout unit is formed to a portion between the closed portion 16 and the fastener 13.

### FIELD OF THE INVENTION

The present invention relates to a packaging bag with fastener for freely opening and closing a spout of the bag and a method of manufacturing such bag.

### BACKGROUND ART

Conventionally, there is provided a packaging bag provided with a fastener at its spout. According to such packaging bag provided with the fastener, the spout can be again closed and sealed after once opened, and thereafter, the spout can be repeatedly opened or closed by opening or closing the fastener. Many prior art publications have disclosed for such packaging bag provided with the fastener.

Among these packaging bags provided with the fasteners, there is a packaging bag, such as disclosed in Patent Publication 1, for example, in which an upper corner portion of the packaging bag functions as a spout for easily taking out an inner content. In the packaging bag disclosed in this Patent Publication 1, the upper corner portion is obliquely opened to form the spout, and in this packaging bag, a fastener is provided inside the spout to be opened so that the spout, which was once opened, is again closed and sealed.

This fastener includes a male fastener part and a female fastener part, and base portions of these parts are bonded to an inner surface of the packaging bag.

Patent Publication 1: Japanese Patent Unexamined Application Publication No. 2002-284195

### DISCLOSURE OF THE INVENTION

### PROBLEMS TO BE SOLVED BY THE INVENTION

However, according to the packaging bag disclosed in the Patent Publication 1, it is difficult to maintain an opened state of the spout at the time of taking out the inner content after opening the seal, and it is necessary to intentionally open the spout with a desired opened size, involving a troublesome operation. Therefore, it was difficult to take out the inner content by a desired amount.

In addition, in order to attach the fastener to the corner portion of the packaging bag, it is necessary to attach the same with no positional shifting of the fastener, which will involve cost increasing for attaching the fastener with high accuracy.

Then, an object of the present invention is to provide a packaging bag with a fastener capable of extremely easily maintaining an opened state of a spout of the packaging bag and being manufactured with high quality at a low cost.

### MEANS FOR SOLVING THE PROBLEM

In order to solve the above problem, the present invention provides a packaging bag with a fastener, comprising: a bag body formed with a mount opening; and a spout unit formed of a material different from the bag body and connected to the mouth opening so as to serve as a spout for taking out an inner content contained in the bag body, wherein the spout unit includes wall surface portions composed of a pair of opposing surfaces whose end edges are connected and a fastener composed of a male fastener part provided on an inner surface of one of the paired surfaces and a female fastener part provided on an inner surface of another one of the paired surfaces, the wall surface portions and the fastener being integrally formed through an injection molding process, the spout unit has a bottom side end portion constituting a connection opening to be connected to the mount opening of the bag body and a top side end portion constituting an end closed portion, with the fastener being boundary thereof, and a seal-opening portion is formed to the wall surface portions between the closed portion and the fastener for tearing the wall surface portions so that the spout unit is separated into the closed portion side and the fastener side.

Furthermore, in the present invention, in the above packaging bag with the fastener, the connected end edges of the wall surface portions constitute end folded line portions formed by bending the wall surface portions, the wall surface portions are formed such that the central folded line portions bent together with male and female fastener parts formed to the respective wall surface portions are formed in directions perpendicular to an extending direction of the male and female fastener parts at central portions thereof, and the respective wall surface portions are bent at the central folded line portions so that the respective central folded line portions protrude in directions oppositely separated from each other.

Furthermore, in the present invention, in the packaging bag with the fastener, the spout unit is formed to be tapered toward the end closed portion of the wall surface portions so that the end folded line portion and the central folded line portions constitute side lines of a quadrangular pyramid shape.

Furthermore, in the present invention, in the packaging bag with the fastener, the male and female fastener parts are provided such that central side portions thereof from both end portions in the axial directions thereof are positioned either one side of the closed portion side or connection opening side of the wall surface portions, and the bent portions of the male and female fastener parts are positioned on the central folded line portions.

Furthermore, in the present invention, in the packaging bag with the fastener, the seal-opening portion is formed to be linear so as to connect both side portions of the spout unit, and a tearing starting portion is formed to at least one of the side portions of the spout unit so as to be positioned on a same straight line of the seal-opening portion and strength of the side portion of the spout unit is locally weakened.

Furthermore, in the present invention, in the packaging bag with the fastener, the spout unit is formed with a holding hole for holding the spout unit to a constant attitude by means of a holding member at a time of connecting the spout unit to the bag body, and the holding hole is formed between the seal-opening portion and the end closed portion.

According to the present invention, the following manufacturing method for manufacturing the above-mentioned packaging bag with the fastener is adopted.

That is, there is provided a method of manufacturing a packaging bag with a fastener comprising: a bag body forming step for forming a bag body into which an inner content is accommodated; a spout unit forming step for forming a spout unit to be connected to the bag body so as to serve a spout for pouring out the inner content; and a connecting step for connecting the spout unit to the bag body, wherein, in the bag body forming step, a mount opening to which the spout unit is connected is formed to the bag body, and wherein, in the spout unit forming step, wall surface portions and a fastener are integrally formed by means of injection molding, in which the wall surface portions are formed by connecting both end edges of opposing surfaces, a fastener is composed of a male fastener part formed to an inner surface of one of the wall surface portions and a female fastener part formed to an inner surface of another one of the wall surface portions so as to be engageable with the male fastener part, and the wall surface portions include one side end portions constituting a connection opening portion to be connected to the mount opening of the bag body and another side end portion constituting an end closed portion of the end edge of the packaging bag.

Furthermore, in the present invention, in the packaging bag manufacturing method mentioned above, the spout unit forming step includes an injection molding step for injecting resin material into a mold including a cavity, having a quadrangular-pyramid shape, composed of four spaces including one pair of adjacent spaces in which the male fastener part is formed and another one pair of adjacent spaces in which the female fastener part is formed, and among four side lines forming the cavity, the side lines oppositely positioned and forming boundaries between the one paired spaces and another one paired spaces connect the respective wall surface portions of the spout unit and constitute end folded line portions to form the wall surface portions to be foldable, and on the other hand, the side lines oppositely positioned and forming a boundary between adjacent spaces of the respective spaces and constitute central folded line portions positioned to central portions of the wall surface portions.

Furthermore, in the present invention, in the packaging bag manufacturing method mentioned above, the cavity formed by the mold is provided with a portion for forming a seal-opening portion for separating the spout unit into the fastener portion and the end closed portion between a portion to which the male fastener part and female fastener part are formed and the top portion of the cavity, thereby forming the seal-opening portion in the spout unit forming step.

Furthermore, in the present invention, in the packaging bag manufacturing method mentioned above, a holding hole is formed between the seal-opening portion and the closed portion of the spout unit, and in the connecting step, a parts feeder fed to means for connecting the spout unit to the bag body so as to constantly hold an attitude of the spout unit.

### EFFECTS OF THE INVENTION

According to the present invention, when the inner content is poured out from the packaging bag with the fastener, the shape of the seal-opening portion can be maintained in the opened state. Because of this reason, at the inner content pouring time, it is inhibited that the wall surface portions of the spout unit obstruct the pouring operation, and the predetermined amount of the inner content can be easily taken put. In addition, since there is provided the fastener, the remaining inner content can be surely stored as in the prior art.

### BRIEF DESCRIPTION OF THE DRAWINGS

FIG. 1 is a front view of a standing pouch according to one embodiment of the present invention.

FIG. 2 is a plan view of a spout unit used for the standing pouch of FIG. 1.

FIG. 3 is a perspective view of the spout unit shown in FIG. 2.

FIG. 4 is a view showing a shape of an insertion hole for inserting a parts feeder into the spout.

FIG. 5 is a view showing a fastener provided with a male fastener part and a female fastener part which are engaged together.

FIG. 6 is a view showing the fastener provided with a male fastener part and a female fastener part which are separated.

FIG. 7 is a view showing a fastener according to an embodiment different from that shown in FIG. 5 or 6.

FIG. 8 is an elevational sectional view of a mold.

FIG. 9 is a cross sectional view of the mold.

FIG. 10 is an enlarged view of a fastener forming portion.

FIG. 11 is a perspective view of a spout unit into which a parts feeder is inserted.

FIG. 12 is a view showing a using mode of the standing pouch shown in FIG. 1.

FIG. 13 is a view showing a state that a seal-opening portion is opened and an inner content is taken out from the standing pouch.

FIG. 14 is a plan view showing a spout unit according to another embodiment.

FIG. 15 is a front view, partially cut away, of a standing pouch according to an embodiment different from that of FIG. 1.

### EXPLANATION OF REFERENCE NUMERAL

1, 100 - - - standing pouch (packaging bag provided with fastener), 2, 102 - - - bag body, 3, 70, 102 - - - spout unit, 9, 111 - - - mount opening portion, 11, 71, 121 - - - wall surface, 13, 13A, 73, 123 - - - fastener, 14, 74, 124 - - - bent portion, 15, 76, 126 - - - connection opening portion, 16, 75, 126 - - - closed portion, 17, 77, 127 - - - end folded line portion, 18, 78, 128 - - - central folded line portion, 20, 79, 130 - - - seal-opening portion, 21, 81, 132 - - - insertion hole (holding hole), 25, 30 - - - male fastener part, 26, 31 - - - engaging pawl, 27, 35 - - - female fastener part, 28, 36 - - - engaging wall, 40 - - - mold, 43 - - - cavity

### BEST MODE FOR EMBODYING THE INVENTION

Hereunder, an embodying mode of the present invention will be described with reference to the accompanying drawings.

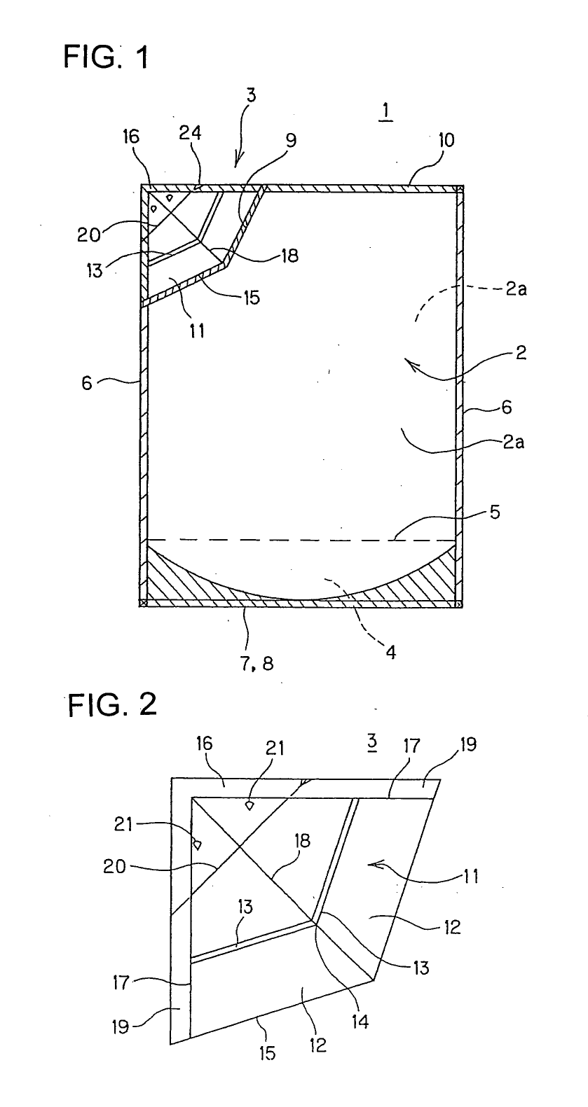

FIG. 1 is a front view of a standing pouch 1 as a packaging bag with a fastener according to one embodiment of the present invention. This standing pouch 1 includes a bag body 2 and a spout unit 3 connected to the bag body 2 and adapted to take out an inner content. The bag body 2 is formed from a pair of opposing flat portions 2a and a bottom portion 4 closing the bottom portion. The flat portions 2a are formed into a tubular shape by heat-sealing both side edges 6 thereof. The bottom portion 4 is folded into V-shape and a folded line 5 formed at its central portion directed upward of the standing pouch 1. In addition, the lower end edges 7 of the paired flat portions 2a and the peripheral edge 8 of the bottom portion 4 are heat-sealed to thereby provide an elliptical shape when widening the bottom portion.

The bag body 2 is formed from a laminated film of the structure mentioned hereunder.

ON#15/DL/L-LDPE#50-100

ON#25/DL/CPP#50-100

PET#12/Print/DL/ON#15/DL/L-LDPE#50-100

PET#12/Print/DL/ON#15/DL/CPP#50-100

PET#12/Print/DL/AL6-12μ/DL/ON#15/DL/L-LDPE#50-100

PET#12/Print/DL/ON#15/DL/AL6-12μ/DL/CPP#50-100

wherein the respective symbols are:

ON: biaxial drawing nylon

DL: dry laminate

L-LDPE: linear low density polyethylene

PET: polyethylene telephthalate

CPP: non-oriented polypropylene

#: μm, for example, #15 means 15 μm

On the other hand, the spout unit 3 is connected to a mount opening (opening for mounting) 9 formed to a corner portion of the bag body 2 at its upper portion. At the upper edge 10 of the bag body 2, the opposing flat portions 2a are closed and sealed through a heat-seal process, but at one corner portion of the upper portion, the mount opening 9 to which the spout unit 3 is mounted is formed. The spout unit 3 is connected to this mount opening 9 and attached by being heat-sealed to the bag body 2.

FIGS. 2 to 7 shows the details of the spout unit 3.

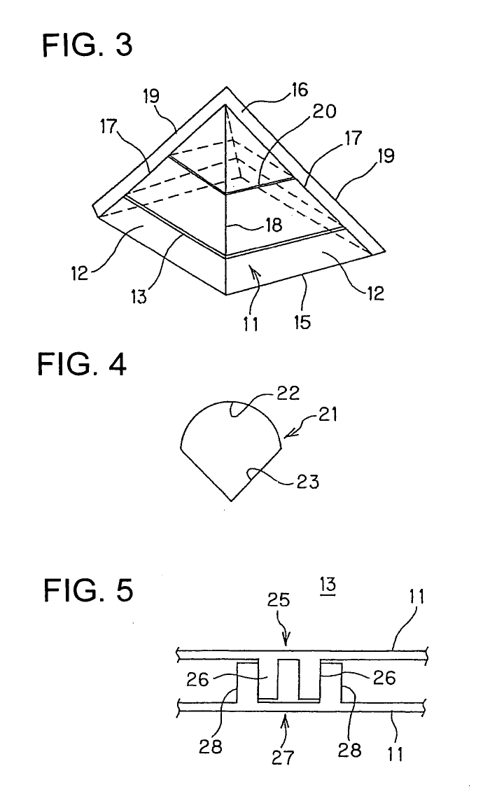

As shown in FIGS. 2 and 3, the spout unit 3 has a pyramid-shaped outer appearance, and is provided with wall surface portion 11 constituting one portion of a circumferential surface of the standing pouch 1 and a fastener 13 provided on the inner surface of the wall surface portion 11. The entire structure of spout unit 3 including these wall surface portion 11 and the fastener 13 is integrally formed through an injection molding process as mentioned hereinafter.

The pyramid-shaped wall surface portion 11 has a top end side closed portion 16 and a bottom side opening 15 to be connected to the bag body 2. The pyramid-shaped four surfaces of the wall surface portion 11 are foldable such that two pairs of the adjacent surfaces 12 are formed. When folded, portions positioned at both side edges are end folded (folding) lines 17 constituting side lines positioned on one diagonal line. Seal portions 19 extending outward of the spout unit 3 are formed to the outsides of the end folded lines 17. On the other hand, the central portion of the wall surface portion 11 when folded is a central folded (folding) line 18 constituting a side line positioned on the other diagonal line. This central folded line 18 is formed by recessing the inner surface of the wall surface portion 11 for the easy opening of the bag body as mentioned hereinafter.

Furthermore, as shown in FIGS. 1 to 3, the connection opening (15) side of the wall surface portion 11 projects so as to be slightly tapered from the end folded line (17) side toward the central folded line (18) side.

Further, on the inner surface of the wall surface portion 11, male fastener parts 25 of the fasteners 13 are provided to the one paired surfaces 12 with the seal portions 19 being boundary, and female fastener parts 27 are provided to the other paired surfaces 12.

The male and female fastener parts 25 and 27 are provides such that the centers thereof in the axial directions are coincident with the central folded lines 18 positioned at the centers of the paired surfaces 12. These male and female fastener parts 25 and 27 are positioned so as to be parallel with the end edges of the bottom portion of the wall surface portion 11, and the center side from both the ends in the axial direction is positioned on the connection opening (15) side so as to form a bent portion 14 at that central portion.

The spout unit 3 is formed with a seal-opening portion 20 for opening the spout unit 3 by tearing it at a portion between the top closed portion 16 of the pyramid-shaped wall surface portion 11 and the fastener 13 so as to separate the torn portion from the spout unit 3.

This seal-opening portion 20 is perpendicular to the central folded line 18 so as to connect both the end folded lines 17 positioned at both side portions of the spout unit 3. Further, the seal portion 19 is formed with a cutout or notch 24 at a position on the same line as the seal-opening portion 20 for easily opening the seal-opening portion 20. Furthermore, in this embodiment, although the cutout 24 is formed as tearing seal-opening starting portion, the present invention is not limited thereto, and for example, the portion on the same line as the seal-opening portion 20 may be formed thinner or as a rough surface portion composed of an aggregation of fine perforations.

Each of the wall surface portions 11 is formed with an insertion hole into which a parts feeder 60 is inserted at a position on the side of the closed portion 16 from the seal-opening portion 20. This insertion hole 21 serves to hold the spout unit 3 in a predetermined direction at a time when the spout unit 3 is grasped by an arm of a supply robot in a step of connecting the spout unit 3 to the bag body 2. For this reason, a plurality of insertion holes, such as two or three holes 21 may be formed so as to surely determine the direction. However, the formation of only one insertion hole 21 is not inhibited. Furthermore, the insertion hole 21 may have a general rectangular shape or rhombus, but if the insertion hole is formed so as to provide a circular upper portion 22 and a lower portion 23 finely tapered downward to thereby ensure the vertical and horizontal positioning.

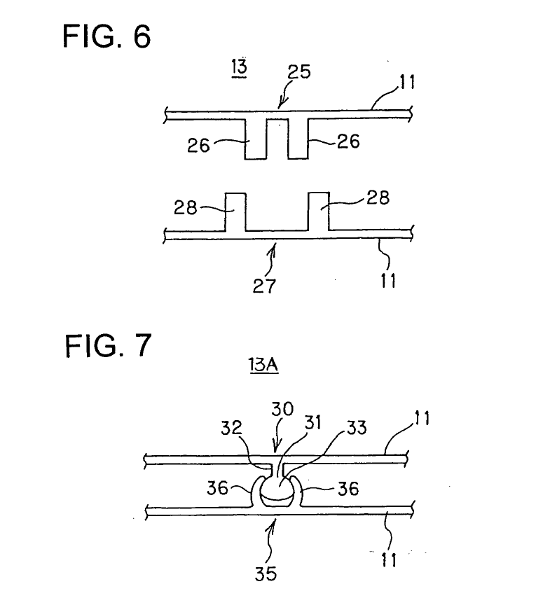

FIGS. 5 and 6 show cross sectional views of the male fastener part 25 and the female fastener part 27, in which FIG. 5 shows a state that both the fastener parts are engaged with each other and FIG. 6 shows a state that both the fastener parts are separated.

The male fastener part 25 of the fastener 13 is composed of a pair of engaging pawls 26 each having a rectangular shape in section and projecting from the inner surface of the wall surface portion 11 so as to be perpendicular thereto. These paired engaging pawls 26 are formed with a constant interval therebetween along the entire length of the male fastener part 25. On the other hand, the female fastener part 27 of the fastener 13 is composed of a pair of engaging wall sections 28 each having a rectangular shape in section and projecting from the inner surface of the wall surface portion 11 so as to be perpendicular thereto. These paired engaging wall sections 28 are formed with a constant interval therebetween, along the entire length of the female fastener part 27, corresponding to the dimension between the outer surfaces of the engaging pawls 26 of the male fastener part 25.

In the fastener 13, the male fastener part 25 and the female fastener part 27 are engaged in a manner such that the engaging pawls 26 of the male fastener part 25 are inserted into the engaging wall sections 28 of the female fastener part 27, thereby the fastener 13 being closed. Accordingly, even after the seal-opening portion 20 is torn and cut away to open the packaging bag, the packaging bag can be again closed and sealed.

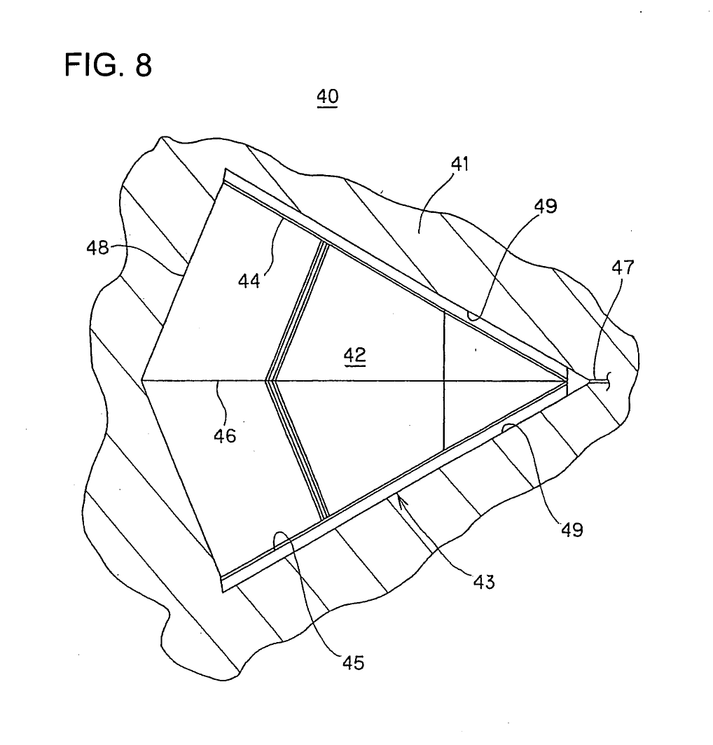

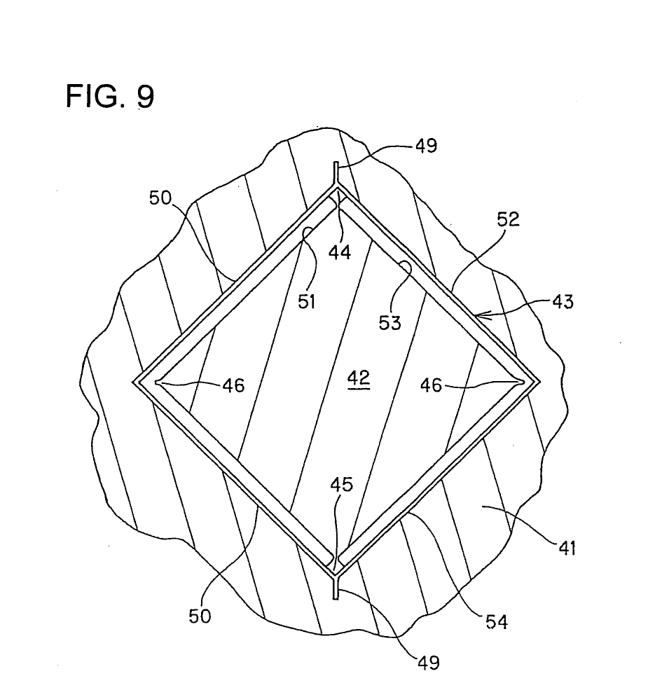

Further, a fastener 13A shown in FIG. 7 may be utilized.

Referring to FIG. 7, the male fastener part 30 is formed from an engaging pawl 31 in form of one row of thread projecting from the inner surface of the wall surface portion 11. The engaging pawl 31 has a root portion 32 having a flat plate shape perpendicular to the wall surface portion 11 and has a front end portion 33 having substantially circular shape in section. On the other hand, a female fastener part 35 is composed of a pair of opposing engaging wall sections 36 so as to project from the inner surface of the wall surface portion 11. The engaging wall sections 36 constituting the female fastener part 35 have a circular-arc shape in section having a partially cut-away portion. In such fastener 13A, as shown in FIG. 7, both the male and female fastener parts 30 and 35 are engaged in a manner such that the front end portion 33 of the engaging pawl 31 constituting the male fastener part 30 is fitted into the engaging wall sections 36 constituting the female fastener part 35.

Incidentally, although the spout unit 3 may be formed by the injection molding by utilizing a general resin material, it is preferred to use a shape memory resin. As explained herein after, by using the shape memory resin, it becomes possible to easily maintain the opened state of the seal-opening portion 20 of the spout unit 3. As such shape memory resin, there may be used, for example, polyester, polyurethane, styrene-butadiene, polynolbornene, transpolyisoprene, or like.

An example of a mold 40 utilized for the manufacture of the spout unit 3 mentioned hereinabove is shown in FIGS. 8 to 10.

The mold 40 is composed of an outside section 41 and an inside section 42 between which a pyramid-shaped thin cavity 43 is formed. In FIG. 8, oblique side portions 44 and 45 positioned above and below the cavity 43 correspond to the positions forming the end folded lines 17, and on the other hand, a center line 46 extending horizontally at the central portion of the inside section 42 corresponds to the portion forming the central folded line 18. Portions 49 extending outward from the upper and lower oblique portions 44 and 45 form seal forming portions 49 forming the seal portion 19 of the spout unit 3. Furthermore, in FIG. 8, a portion constituting the top portion of the cavity 43 forms a resin pouring port 47, and a bottom side portion of the cavity 43 is a portion forming the connection opening 15 of the spout unit 3. Lines 48 connecting the bottom ends of the cavity 43 and the center line 46 are tapered at the central position thereof as shown in FIG. 8.

Further, in a space 50 forming the wall surface portion 11 composed of a pair of one side surfaces 12, a male fastener part forming portion 51 constituting the male fastener part 25 is formed, and on the other hand, in a space 51 forming the wall surface portion 11 composed of another pair of one side surfaces 12, a female fastener part forming portion 53 constituting the female fastener part 27 is formed as shown in FIG. 9. These male fastener part forming portion 51 and the female fastener part forming portion 53 are positioned so as to be parallel with the bottom side lines 48 forming the connection opening 15, and its central side is positioned to the bottom side than the upper and lower ends thereof as shown in FIG. 8.

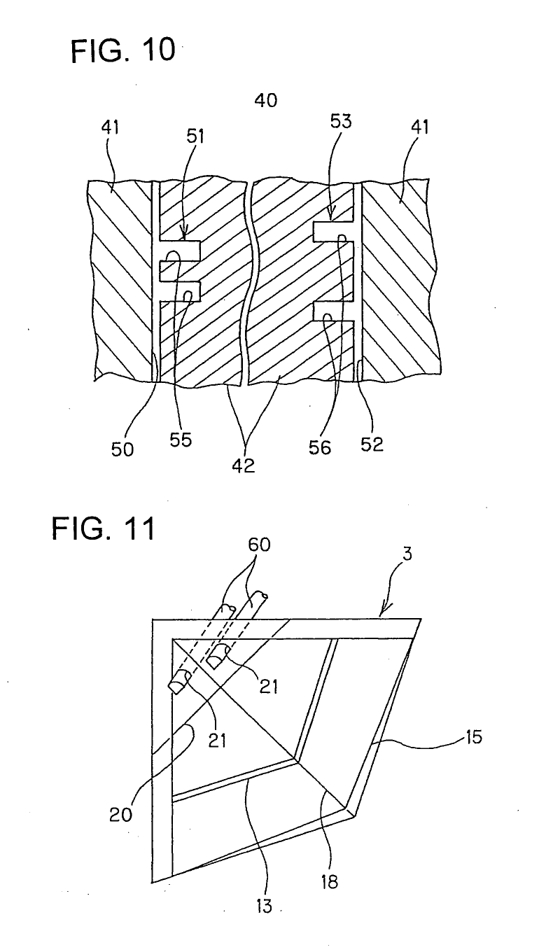

Further, the details of the male fastener part forming portion 51 and the female fastener part forming portion 53 are shown in FIG. 10.

With reference to FIG. 10, the male fastener part forming portion 51 is formed by arranging, in parallel, two spaces each having a rectangular shape in section, at the inside section 42 constituting the mold 40. These rectangular-shaped spaces are engaging pawl forming portions 55 forming the engaging pawls 26 of the male fastener part 25. The engaging pawl forming portion 55 is formed, as is apparent from FIG. 10, so as to be integral with the space 50 forming the wall surface portion 11.

On the other hand, in the inside section 42 of the mold, the female fastener part forming portion 53 is formed at a portion opposite to the center line. In the female fastener part forming portion 53, likely, two spaces each having a rectangular shape in section are formed in parallel with each other. These spaces are engaging pawl forming portions 56 for forming the engaging wall sections 28. These engaging pawl forming portions 56 are also formed to be integral with the space 52 forming the wall surface portion 11.

The wall surface portions 11 and the fastener 13 of the spout unit 3 are formed integrally by injecting the resin in the mold 40 of the structure mentioned above.

The standing pouch of the structure mentioned above will be manufactured through the following steps.

Referring now back to FIG. 1, the bag body 2 is formed by utilizing the flat portions 2a and the V-shaped bottom portion 4. The bottom portion 4 is sandwiched between two flat portions 2a with the folded line being directed upward of the standing pouch 1. At the side portions of the bag body 2, the side edges 6 of the flat portions 2a are heat-sealed together, and at the lower portion thereof, the lower end edges 7 of the flat portions 2a, the lower portion of the side edges 6 and the peripheral edge 8 of the bottom portion 4 are heat-sealed together. Thereafter, one corner portion of the upper portion of the bag body 2 is cut away, thus forming the mount opening 9. The mount opening 9 may, however, be preliminarily formed to the flat portions 2a.

The spout unit 3 is injection-molded by using the mold of the structure mentioned above. The injection molding is performed by injecting the resin from the top side of the pyramid-shaped cavity 43 formed to the mold 40. Upon the injection molding, as shown in FIGS. 2 and 3, the pyramid-shaped spout unit 3 is formed. Thereafter, the insertion holes 21 into which the parts feeders 60 are inserted are formed between the top closed portion 16 and the seal-opening portion 20 of the spout unit 3.

As mentioned above, the bag body 2 and the spout unit 3 are formed, and then, the spout unit 3 is connected to the bag body 2. At this time, the parts feeders 60 are utilized and conveyed to connection stage, not shown, of the bag body 2 and the spout unit 3 in a state that the spout unit 3 is directed to the predetermined direction. The parts feeders 60 serve as holding means for holding the spout unit 3 in a constant attitude. The spout unit is conveyed by the parts feeders 60 so that the connection opening 15 of the spout unit 3 makes coincident with the mount opening 9 of the bag body 2 by using a robot arm, not shown.

Next, the connection opening portion 15 and the mount opening portion 9 are bonded, and then, the spout unit 3 is connected to the bag body 2. In this operation, the seal portion 19 formed to the spout unit 3 is coincident with the side edges 6 and the upper edge 10 of the bag body 2. Further, in this step, only the seal portion 19 of the spout unit 3, in all the seal portions 19, coincident with the side edge 6 of the bag body 2 is sealed together, and the inner content is fed into the bag body 2 through the upper portion of the bag body that is not sealed and opened, and thereafter, the upper edge of the bag body 10 is heat-sealed.

In this step, only the seal portion 19 in all the seal portions of the spout unit 3 coincident with the upper edge of the bag body 2 is heat-sealed together with the upper edge 10, so that both the spout unit 3 and the bag body 2 can be completely connected to each other.

Thereafter, the cutout 24 for seal-opening is formed to the same axial position as the seal-opening portion 20 at the seal portion 19 of the spout unit 3, thus completing the standing pouch 1.

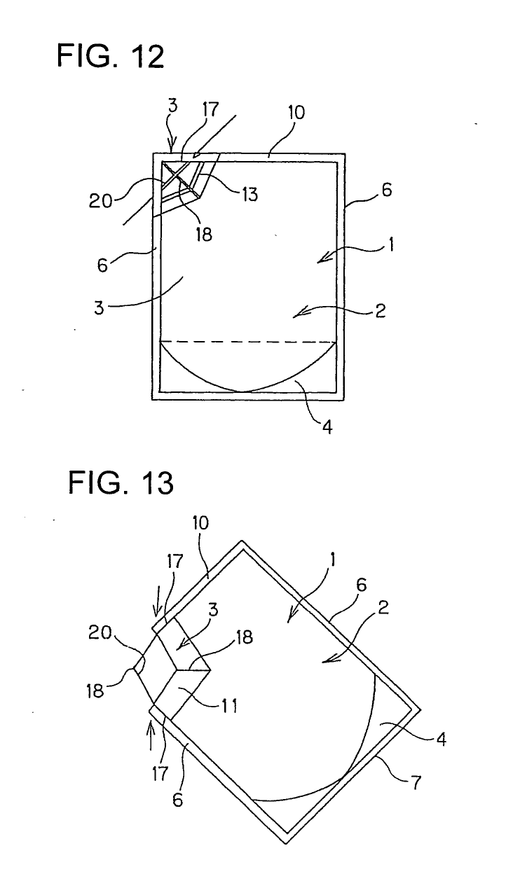

The standing pouch 1 composed of the bag body 2 and the spout unit 3 of the structures mentioned above is used in a manner shown in FIGS. 12 and 13. Further, this standing pouch 1 is suitable for containing either one of liquid material or particle material. As the liquid material, there is listed, as an example, shampoo, linth, liquid soup, food oil, service condiment, or like, and as the particle material, there is listed, as an example, pet food, service condiment, or like.

FIG. 12 shows a state that the inner content fills the standing pouch 1, which is then closed and sealed. In this sealed condition, the bag body 2 can be opened by tearing the seal-opening portion 20 of the spout unit 3. Since the seal-opening portion 20 is positioned between the top closed portion 16 and the fastener 13 of the spout unit 3, the top closed portion 16 is separated from the spout unit by tearing the seal-opening portion 20.

FIG. 13 shows the seal-opened state. In order to make large the opening size of the seal-opening portion 20, the upper edge 10 and the side edges 6 of the standing pouch 1 are pushed toward each other as shown with arrows. Thereby, the center folded lines 18 formed to the wall surface portions 11 of the spout unit 3 are protruded outward so as to be separated from each other, and as a result, the seal-opening portion 20 is opened in shape of rhomb.

Since the spout unit 3 is formed of resin, the wall surface portions 11 thereof have high rigidity, and since the end folded lines 17 and the center folded lines 18 are formed, the wall surface portions 11 can be easily folded at the positions of the center folded lines 18. In addition, at the positions of the center folded lines 18, lines to be folded are formed to both the male and female fastener parts 25 and 27 constituting the fastener 13 and the bent portions 14 are also formed. Therefore, the opposing male and fastener parts 25 and 27 are easily separated from each other, and the seal-opening portion 20 opened in shape of rhomb is maintained in its opened state, whereby the inner content can be easily poured out. This means that a required amount of the inner content can be easily taken out.

After the pouring out of the inner content, the engaging pawls 26 of the male fastener part 25 are engaged with the engaging wall sections 28 of the female fastener part 27 to thereby close and seal the seal-opening portion 20.

Further, this standing pouch 1 is suitable for containing creamy material other than the liquid material and particle material, such as for example, cream applied on a surface of a decoration cake. In this case, by suitably setting the opening size or dimension of the seal-opening portion 20, the standing pouch 1 can be itself utilized as a cream injector, thus being convenient.

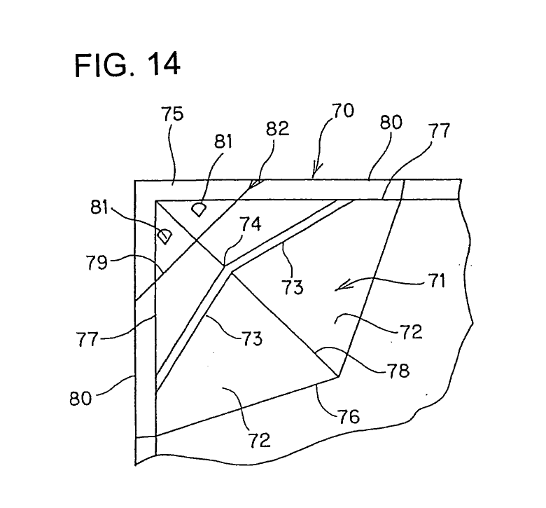

In the above disclosure, although there is explained the mode in which the bent portion is positioned on the connection opening side forming the pyramid-shaped bottom rather than the end folded line side at the time of attaching the fastener, as shown in FIG. 14, the bent portion may be positioned on the closing side 75 constituting the top portion of the pyramid-shape. The spout unit 70 shown in FIG. 14 also has a pyramid-shaped outer appearance and includes a wall surface portion 71 constituting a portion of a peripheral surface of the standing pouch and a fastener 73 provided on the inner surface of the wall surface portion 71, which are formed integrally with each other.

The top side portion of the pyramid-shape structure is formed as the closing portion 75, and its bottom portion is opened as a connection opening 76 which is connected to the bag body. Further, as like the spout unit 3 in the former embodiment, the spout unit 70 is also formed to be foldable. The end folded line portions 77 forming side lines positioned on one diagonal line constitutes portions positioned to both side edges thereof when folded. A seal portion extending toward outside of the spout unit 70 is provided on the outside of the end folded line portion 77. On the other hand, the central portion when folded constitutes the central folded line portion 78 formed from a side line positioned on the other diagonal line. The central folded line portion 78 is formed by recessing the inner surface of the wall surface portion 71 for easy opening as mentioned hereinafter.

The fastener 73 is composed of a male fastener part and a female fastener part, and central portions of these fastener parts in the axial direction coincide with the central folded line portion 78 positioned on the paired centers of the surfaces. The fastener 73 has a central side positioned axially inside from both the ends and positioned on the closed portion (75) side forming the pyramid-shaped top portion, and the bent portions 74 are formed on the center portions.

As mentioned above, in the mode in which the center of the fastener 73 is formed so as to protrude on the side of the closed portion 75, the fastener 73 serves as “watering pot” at the time of taking out the inner content so that small particle powders, for example, can be smoothly pouring out.

Furthermore, a seal-opening portion 79 is formed on the side of the closed portion 79 rather than the fastener 73. Insertion holes 81 for inserting parts feeders are formed between the seal-opening portion and the closed portion 75.

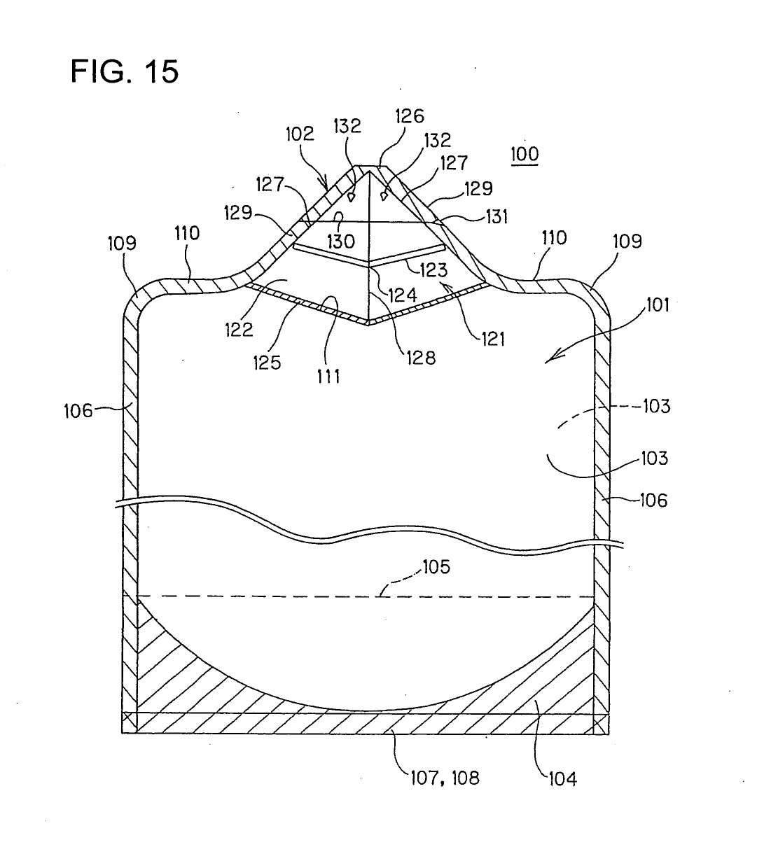

As mentioned above, although the example in which the spout unit is disposed to the corner portion at the upper portion of the standing pouch, the present invention is not limited to this example, and as shown in FIG. 15, the spout unit may be provided to the central portion in the width direction of the standing pouch.

This standing pouch 100 includes a bag body 101 and a spout unit 102 which is connected to the bag body 101 and through which an inner content is taken out. The bag body 101 is composed of a pair of opposing flat surface portions 103 and a bottom surface portion 104 closing the bottom. The flat surface portions 103 are heat-sealed at their side edges so as to provide a tubular structure. The bag body 101 has an upper corner portions 109 each having a circular-arc (round) shape so as to connect an upper edge 110 and side edges 106. In addition, the central portion in the width direction of the bag body 101 is formed with a mount opening 111 by cutting out it so as to provide a V-shape toward downward of the bag body 101. On the other hand, the bottom surface portion 104 is folded into V-shape, and a folded line 105 at the center of the folded bottom portion 104 is directed upward of the standing pouch 100. Furthermore, the lower end edges 107 of the paired flat surface portions 103 and the peripheral edge 108 of the bottom surface portion 104 are heat-sealed so as to provide substantially elliptical shape when widening the bottom portion 104.

This standing pouch 100 is formed from a film material such as laminated film as shown in FIG. 1.

Incidentally, the spout unit 102 is provided so as to project upward from the upper portion of the bag body 101 at the central portion in the width direction of the bag body 101. The spout unit 102 has a structure as like as that of the standing pouch 100 shown in FIG. 1.

That is, the wall surface portions 121 formed as one portion of the flat surface portions 10 of the standing pouch 103 have the pyramid-shaped appearance and are provided with the fastener 123 on the inner surfaces of the wall surface portions 121. Further, the spout unit 102 including the wall surface portions 121 and the fastener 123 are all integrally formed by the injection molding process.

The wall surface portion 121 has its pyramid-shaped top portion as closed portion 126 and has the opened bottom portion, which serves as the connection opening 125 connected to the bag body 101. The wall surface portion 121 is foldable so as to provide two paired adjacent surface portions 122. When folded, the portions positioned on both side edges constitute the end folded line portions 127 forming the sides positioned on one diagonal line. To these portions, the seal portions 129 are formed so as to protrude outward. On the other hand, the central portion at the time of being folded constitutes the central folded line portion 128 forming the side line positioned on the other diagonal line. This central folded line portion 128 is formed by recessing the inner surface of the wall surface portion 121. Further, the connection opening 125 connected to the bag body 101 projects to the bag body side so as to be tapered toward the central folded line portion side from the end folded line portions 127.

Incidentally, the male fastener part of the fastener 123 is provided on the inner surface of the wall surface portion 121 forming one pair of the surfaces 122 with the end folded line portions 127 being boundary thereof, and on the other hand, the female fastener part of the fastener 123 is provided on the inner surface of the other wall surface portion 121 forming the other pair of the surfaces 122. These male and female fastener parts have centers in the axial directions which are coincident with the central folded line portions 128 centrally positioned on the respective paired surfaces 122. Furthermore, these male and female fastener parts are disposed to be parallel with the connection opening 125 of the wall surface portion 121, and the bent portion 124 is formed to the center portion thereof These male and female fastener parts of the fastener 123 are substantially the same structure as that shown in FIGS. 5 to 7.

Furthermore, the spout unit 102 is provided with a seal-opening portion 130, between the closed top portion 126 and the fastener 123, which can be cut away so that the top portion is separated from the spout unit 102. This seal-opening portion 130 is perpendicular to the central folded line portion 128 so as to connect the end folded line portions 127 positioned on both the side portions of the spout unit 102. Further, the seal portion 129 is formed with a cutout 131 at the position on the same line as the seal-opening portion 130 so as to be easily opened. Parts feeder insertion holes 132 are also formed to the wall surface portions 121 between the seal-opening portion 130 and the top closed portion 126.

Further, in this embodiment, the central portion of the fastener may be bent toward the to closed portion side.

1. A packaging bag with a fastener comprising a bag body formed with a mount opening and a spout unit formed of a material different from the bag body and connected to the mouth opening of the bag body so as to serve as a spout for taking out an inner content contained in the bag body,
wherein the spout unit includes wall surface portions composed of a pair of opposing surfaces whose end edges are connected and a fastener composed of a male fastener part provided on an inner surface of one of the paired surfaces and a female fastener part provided on an inner surface of another one of the paired surfaces, the wall surface portions and the fastener being integrally formed through an injection molding process,
the spout unit has a bottom side end portion constituting a connection opening to be connected to the mount opening of the bag body and a top side end portion constituting an end closed portion, with the fastener being boundary thereof, and
a seal-opening portion is formed to the wall surface portions between the closed portion and the fastener for tearing the wall surface portion so that the spout unit is separated into the closed portion side and the fastener side.

2. The packaging bag with the fastener according to claim 1, wherein the connected end edges of the wall surface portions constitute end folded line portions formed by bending the wall surface portions, the wall surface portions are formed such that the central folded line portions bent together with male and female fastener parts formed to the respective wall surface portions are formed in directions perpendicular to an extending direction of the male and female fastener parts at central portions thereof, and the respective wall surface portions are bent at the central folded line portions so that the respective central folded line portions protrude in directions oppositely separated from each other.

3. The packaging bag with the fastener according to claim 2, wherein the spout unit is formed to be tapered toward the end closed portion of the wall surface portions so that the end folded line portion and the central folded line portions constitute side lines of a quadrangular pyramid shape.

4. The packaging bag with the fastener according to claim 3, wherein the male and female fastener parts are provided such that central side portions thereof from both end portions in the axial directions thereof are positioned either one side of the closed portion side or connection opening side of the wall surface portions, and the bent portions of the male and female fastener parts are positioned on the central folded line portions.

5. The packaging bag with the fastener according to claim 1, wherein the seal-opening portion is formed to be linear so as to connect both side portions of the spout unit, and a tearing starting portion is formed to at least one of the side portions of the spout unit so as to be positioned on a same straight line of the seal-opening portion and strength of the side portion of the spout unit is locally weakened.

6. The packaging bag with the fastener according to claim 1, wherein the spout unit is formed with a holding hole for holding the spout unit to a constant attitude by means of a holding member at a time of connecting the spout unit to the bag body, and the holding hole is formed between the seal-opening portion and the end closed portion.

7. A method of manufacturing a packaging bag with a fastener comprising:
a bag body forming step for forming a bag body into which an inner content is accommodated;
a spout unit forming step for forming a spout unit to be connected to the bag body so as to serve a spout for pouring out the inner content; and
a connecting step for connecting the spout unit to the bag body,
wherein, in the bag body forming step, a mount opening to which the spout unit is connected is formed to the bag body, and
wherein, in the spout unit forming step, wall surface portions and a fastener are integrally formed by means of injection molding, in which the wall surface portions are formed by connecting both end edges of opposing surfaces, a fastener is composed of a male fastener part formed to an inner surface of one of the wall surface portions and a female fastener part formed to an inner surface of another one of the wall surface portions so as to be engageable with the male fastener part, and the wall surface portions include one side end portions constituting a connection opening portion to be connected to the mount opening of the bag body and another side end portion constituting an end closed portion of the end edge of the packaging bag.

8. The method of manufacturing the packaging bag with the fastener according to claim 7, wherein the spout unit forming step includes an injection molding step for injecting resin material into a mold including a cavity, having a quadrangular-pyramid shape, composed of four spaces including one pair of adjacent spaces in which the male fastener part is formed and another one pair of adjacent spaces in which the female fastener part is formed, and among four side lines forming the cavity, the side lines oppositely positioned and forming boundaries between the one paired spaces and another one paired spaces connect the respective wall surface portions of the spout unit and constitute end folded line portions to form the wall surface portions to be foldable, and on the other hand, the side lines oppositely positioned and forming a boundary between adjacent spaces of the respective spaces and constitute central folded line portions positioned to central portions of the wall surface portions.

9. The method of manufacturing the packaging bag with the fastener according to claim 8, wherein the cavity formed by the mold is provided with a portion for forming a seal-opening portion for separating the spout unit into the fastener portion and the end closed portion between a portion to which the male fastener part and female fastener part are formed and the top portion of the cavity, thereby forming the seal-opening portion in the spout unit forming step.

10. The method of manufacturing the packaging bag with the fastener according to claim 9, wherein a holding hole is formed between the seal-opening portion and the closed portion of the spout unit, and in the connecting step, a parts feeder fed to means for connecting the spout unit to the bag body so as to constantly hold an attitude of the spout unit.

11. The packaging bag with the fastener according to claim 2, wherein the seal-opening portion is formed to be linear so as to connect both side portions of the spout unit, and a tearing starting portion is formed to at least one of the side portions of the spout unit so as to be positioned on a same straight line of the seal-opening portion and strength of the side portion of the spout unit is locally weakened.

12. The packaging bag with the fastener according to claim 3, wherein the seal-opening portion is formed to be linear so as to connect both side portions of the spout unit, and a tearing starting portion is formed to at least one of the side portions of the spout unit so as to be positioned on a same straight line of the seal-opening portion and strength of the side portion of the spout unit is locally weakened.

13. The packaging bag with the fastener according to claim 4, wherein the seal-opening portion is formed to be linear so as to connect both side portions of the spout unit, and a tearing starting portion is formed to at least one of the side portions of the spout unit so as to be positioned on a same straight line of the seal-opening portion and strength of the side portion of the spout unit is locally weakened.

14. The packaging bag with the fastener according to claim 2, wherein the spout unit is formed with a holding hole for holding the spout unit to a constant attitude by means of a holding member at a time of connecting the spout unit to the bag body, and the holding hole is formed between the seal-opening portion and the end closed portion.

15. The packaging bag with the fastener according to claim 3, wherein the spout unit is formed with a holding hole for holding the spout unit to a constant attitude by means of a holding member at a time of connecting the spout unit to the bag body, and the holding hole is formed between the seal-opening portion and the end closed portion.

16. The packaging bag with the fastener according to claim 4, wherein the spout unit is formed with a holding hole for holding the spout unit to a constant attitude by means of a holding member at a time of connecting the spout unit to the bag body, and the holding hole is formed between the seal-opening portion and the end closed portion.

17. The packaging bag with the fastener according to claim 5, wherein the spout unit is formed with a holding hole for holding the spout unit to a constant attitude by means of a holding member at a time of connecting the spout unit to the bag body, and the holding hole is formed between the seal-opening portion and the end closed portion.
